(19) United States
(12) Patent Application Publication
(10) Pub. No.: US 2014/0283124 A1
(43) Pub. Date: Sep. 18, 2014

(54) Method for Managing Access to Documents Protected by Digital Rights Management

(71) Applicants: William Chang, Mountain View, CA (US); Daniel BARBER, Tustin, CA (US)

(72) Inventors: William Chang, Mountain View, CA (US); Daniel BARBER, Tustin, CA (US)

(73) Assignee: KONICA MINOLTA LABORATORY U.S.A., INC., San Mateo, CA (US)

(21) Appl. No.: 13/837,020

(22) Filed: Mar. 15, 2013

(51) Int. Cl. G06F 21/10

(52) U.S. Cl. CPC G06F 21/10
USPC 726/28

(57) ABSTRACT

A method for managing user access of a document protected by digital rights management (DRM), includes the steps of a server checking whether a user who is attempting to access a DRM-protected document has necessary rights to access the document, the server denying the user's access to the document if the user does not have the necessary rights to access the document, the server providing, if the user does not have the necessary rights to access the document, the user with an instant and pre-prepared prompt containing a unique identification (ID) of the document to direct and assist the user to complete required tasks for acquiring rights to the document, and upon completion of the required tasks by the user, the server granting the necessary rights to the user to access the document.

### BACKGROUND OF THE INVENTION

1. Field of the Invention

This invention relates to a method of managing user access of electronic documents, and in particular, it relates to a method for managing user access to electronic documents protected by digital rights management (DRM).

2. Description of Related Art

With the development of computer and telecommunication technologies, many documents now are generated, distributed and accessed electronically in digital file formats such as the Portable Document Format (PDF).

DRM are widely used to control the access and prevent unauthorized use of digital documents. For example, when a user purchases a digital document to read in its electronic format, DRM will allow the use to read the document in, e.g., PDF while restricting the file to be printed in hard copies. Often times DRM protected documents are user-specific. For example, if one user has paid for a fee to download and read a PDF document, then the PDF document may be associated with the identification (ID) of that user, and another user using a different ID may not be able to open and read the PDF file even if the other user obtain a digital copy of the document from the first user.

Typically a digital file needs to be opened and displayed or otherwise processed by an application program. For example, PDF files are handled by, e.g., Adobe®'s Acrobat Reader program. When a user opens a digital file by using such a program, the program can check to see whether the file is DRM-protected. If the file is DRM-protected, then the program may ask the user to provide a user ID (and password). Depending on the user ID, the program can determine what rights are granted to the user with regard to the file. Often times the program will access a an DRM server via a computer network such as the Internet, and verify the user's ID with a database maintained at the server to determine the user's rights in connection with the file.

There is a need to provide a quick and easy way to users who may not originally have any right to access or use DRM-protected documents to have a chance to seamlessly obtain such rights on the spot upon trying to open such documents.

### SUMMARY

The present invention is directed to a new method of facilitating a user to obtain legal access to DRM-protected documents through a very user friendly process.

An object of the present invention is to provide a method for allowing users who have obtained DRM-protected documents but not yet obtained any right to access the documents to quickly and easily gain legal access to such documents by using a very user friendly purchase process.

Additional features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for managing user access of a document protected by digital rights management (DRM), includes the steps of a server checking whether a user who is attempting to access a DRM-protected document has necessary rights to access the document, the server denying the user's access to the document if the user does not have the necessary rights to access the document, the server providing, if the user does not have the necessary rights to access the document, the user with an instant and pre-prepared prompt containing a unique identification (ID) of the document to direct and assist the user to complete required tasks for acquiring rights to the document, and upon completion of the required tasks by the user, the server granting the necessary rights to the user to access the document.

In a further aspect, another one of the exemplary embodiments of the present invention provides a computer software program product that causes a data processing apparatus to perform the above described methods. The computer program product includes a computer usable non-transitory medium (e.g. memory or storage device) having a computer readable program code embedded therein for controlling a data processing apparatus, the computer readable program code configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating an exemplary data processing apparatus such as a computer or server having a data processing unit according to one of the embodiments of the present invention.

FIG. 3 is a flow chart diagram illustrating an exemplary process according to one of the embodiments of the present invention.

FIG. 4 is a flow chart diagram illustrating an exemplary process according to another one of the embodiments of the present invention.

### DETAILED DESCRIPTION OF PREFERRED EMBODIMENTS

Embodiments of the present invention provide a method for allowing a user to obtain legal access to DRM-protected documents through a very user friendly process. This method makes it very quick and easy for a user who does not have the necessary rights to access and use a DRM-protected document to purchase such rights on-spot and gain immediate access once the required rights are obtained.

Referring to FIG. 1, there is shown a schematic block diagram illustrating an exemplary arrangement 10 in which various embodiments of the present invention may be implemented. The exemplary environment 10 includes a customer or user terminal 20, a learning management system (LMS) server 30, a rights management system (RMS) server 40, and a digital file storage and/or database 50, all connected through a network 60 which may include a computer network such as the Internet or other communication links. Either or both the LMS server 30 and the RMS server 40 may be a content provider server as well as a DRM server.

When computer network such as the Internet is utilized, a customer or user may use the user terminal or computer 20, or similar suitable devices such as a laptop computer, a tablet computer, an e-reader, or a smart phone, etc., to access the computer network 60 and interact with the LMS server 30, etc. An administrator or operator may operate the LMS server 30 to access the network 60 and interact with the customer or user through the user terminal 20, etc. Both the user terminal 20 and the LMS server 30 may have access to the RMS server 50 via the network 60. The storage 50 is accessible by the LMS server 30 and/or the RMS server 40 via the network 60 or directly.

The LMS server 30 may be operated by, for example, an educational institution, and generally provides online electronic documents, books, booklets, publications and other materials in digital files. The LMS server 30 may provide an integrated online service platform such as an online course or webstore that allows users to search, access, upload or download, and purchase electronic documents stored as digital files in its internal storage device or the external storage 50.

The RMS server 40 may be operated by a copyrights management center or other DRM centers. The LMS server 30 and the RMS server may be the same server (operated by a same entity). When an electronic document is purchased by a user in a digital file, the RMS server may enable appropriate DRM protection to the document such that only the user who has purchased the document may have rights to access and view the document. The ID of the document and the ID of the user who purchased the electronic document may be saved in storage/database 50 for future reference. For example, if the document is available online, then the user who purchased the electronic document may access the document at a future time by providing the document ID and his or her user ID, and a search through the database 50 will indicate that the user indeed has rights to access and view the document.

The computers, terminals and servers 20, 30 and 40 used by the user, the LMS and/or the RMS may be computers, server computers, or computer or server systems, such as webservers, where the computer software program(s) and/or application(s) implementing the various processes of the exemplary embodiments of the present invention may be installed and executed.

Typically these computers and servers provide a user interface or graphic user interface to allow users or operators to interact with the computer software programs and applications to perform various steps of the process.

In this Application the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention.

A user typically accesses the computers and server by using computer programs or applications on the users' own computer or on a server that the user can access through a user computer or terminal.

In this Application the term “user” generally refers to anyone who uses the method or related apparatus provided by the embodiments of the present invention.

In addition, in this Application the terms “user” and the server user by the user, or the LMS and the server used by the LMS, or the RMS and the server used by the RMS, may be used interchangeably respectively to refer to such person or entity who uses a server and/or a server that is used by such person or entity to carry out the steps of the process according to the various embodiments of the present invention.

The physical locations or the commercial relationship among the various parts of the environment shown in FIG. 1 are not important. For example, the server of the LMS server 30 and/or the RMS server 40 may be located in an educational institution, an organization or a commercial establishment.

As mentioned earlier, in one aspect, an exemplary embodiment of the present invention is embodied a computer program product that causes a data processing apparatus to perform the exemplary embodiments of the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention as shown in FIG. 2.

Referring to FIG. 2, there is shown a schematic block diagram illustrating an exemplary server 100, whereupon various embodiments of the present invention may be implemented. The server 100 typically includes a user input device 110 including, for example, a keyboard and a mouse. The input device 110 may be connected to the server 100 through a local input/output (I/O) port 120 to enable an operator and/or user to interact with the server 110. The local I/O 120 is also provided for local connections via direct links to other electronic devices such as a file storage, a monitor and/or a printer. The server 100 typically also has a network I/O port 130 for connection to a computer network such as the Internet, so that the server 100 may remotely communicate with the other servers connected to the computer network.

The server 100 typically has a data processor/controller unit 140 such as a central processor unit (CPU) that controls the functions and operations of the server 100. The data processor/controller unit 140 is connected to various memory devices such as a random access memory (RAM) device 150, a read only memory (ROM) device 160, and a storage device 170 such as a hard disc drive or solid state memory. The storage device 170 may be an internal memory device or an external memory device such as a file storage device.

The computer software program codes and instructions for implementing the various embodiments of the present invention may be installed or saved on one or more of these memory devices such as the ROM 160 or storage device 170. When executed, certain computer program codes and/or instructions may be read out from the ROM 160 or storage device 170 and temporarily stored in the RAM 150 for execution by the data processor/controller unit 140, which executes these computer programs codes and/or instructions to perform the functions and carry out the operations to implement the process steps of the various embodiments of the present invention.

The server 100 typically also includes a display device 180 such as a video monitor or display screen which may be connected to the local I/O 120. The input device 110 and the display device 180 together provide a user interface which allows a user to interact with the server 100 to perform the steps of the process according to the various embodiments of the present invention. The input device 110 and the display device 180 may be integrated into one unit, such as a touch screen display unit, to provide a more easy and convenient UI for user interaction with the server 100.

It is understood that the server 100 may be any suitable computer or computer system. Preferably for use, for example, by the LMS 30 or RMS 40, the server 100 is a commercial server. However, for use by a member of the general public, the server 100 may be a desktop computer, a laptop computer, a notebook computer, a netbook computer, a tablet computer, a hand-held portable computer or electronic device, a smart phone, or any suitable data processing apparatus that has suitable data processing capabilities.

Referring to FIG. 3 (and in conjunction with FIG. 1), there is shown a flow chart diagram illustrating an exemplary process in accordance with to one of the embodiments of the present invention for managing user access to documents protected by a digital rights management (DRM) system. The description herein of the structures, functions, interfaces and other relevant features, such as digital rights policies, application programming interface (API) for rights management and policies, etc., of existing DRM method and systems may at times incorporates, references or otherwise uses certain information, documents and materials from publicly and readily available and accessible open sources, e.g., “Rights Management” (URL http://help.adobe.com/en_US/livecycle/10.0/Overview/WS92d06802c76abadb2c8525912ddcb9aad9-7ff8.html), “Programmatically applying policies (a subsection of ‘Rights Management’)”, (URL http://help.adobe.com/en_US/livecycle/10.0/Overview/WSb96e41f8a4ca47a94882aeb5131190eddba-8000.html), “LiveCycle® ES Java™ API Reference” (URL http://livedocs.adobe.com/livecycle/es/sdkHelp/programmer/javadoc/index.html), etc.

The process begins at Step S110, wherein a user tries to access a DRM-protected document. This step is typically performed on a user computer or terminal 20, or at a terminal connected to a content provider server such as the LMS server 30. The DRM-protected document may be stored in a memory or storage device of the user computer or terminal 20 or the LMS server 30.

At Step S112 the program used by the user to try to open the document needs to check whether the user has the appropriate rights to access the document. The program may be a reader program stored in and executed by the user computer. For example, if the document is in PDF, then the program may be Adobe®'s Acrobat Reader program. The program generally needs to access a content provider's server such as the RMS server 40 via the network 60 and provide the ID of the document and the ID of the user, and the step of checking whether the user has the necessary rights may be performed at the RMS server 40. The document ID may be a globally unique ID (GUID). The RMS server may access a database stored in an internal or external memory or storage device (e.g. the storage 50) to see whether the user ID is associated with the document ID as an authorized user. At Step S114 if the RMS server determines that the user is unauthorized, then it will deny the user's access to the document.

At Step S116 a message is generated by the RMS server. Alternatively the message may be generated by the reader program on the user's computer. The message will contain a universal resource location (URL) which can be used to direct the user to the DRM server 40. The URL may also contain the document GUID, and may also contain the user ID. The URL may also contain a policy ID of the document which is associated with the DRM-protected document.

At Step S118 the message containing the URL is displayed to the user on the user's computer or terminal 20 or a terminal connected to the RMS server 40. At Step S120 the user follows the URL to the RMS server 40 to initiate the steps of acquiring necessary rights to access the document.

At Step S122 the RMS server presents a user interface (UI) to the user for the user to purchase or otherwise acquire rights to access the document. At Step S124 the user completes the necessary tasks to purchase or otherwise acquire the rights to the document. Once the user completes the purchasing and registration, at Step S126 the database can be updated with the user's ID can be added to the policy ID associated with the document ID stored in the database. At Step S128 the user is granted rights to access and use the document.

Once the user is granted the rights to access and use the document, at Step S130 the user may open and read the document as the rights are granted.

The dotted boxes in FIG. 3 indicate typically what steps are performed by or at which system. For example, the dotted box on the left indicates that Steps S110, S118-120 and S130 are typically performed at the user's computer (or a terminal connected to the LMS or RMS server), and the dotted box on the right indicates that Steps S112-116 and S122-128 are typically performed by a content provider's server such as the RMS server. However, it is understood that alternative arrangement may be utilized to perform these steps.

Referring to FIG. 4 (and in conjunction with FIG. 1), there is shown a flow chart diagram illustrating an exemplary process in accordance with another one of the embodiments of the present invention. The process also begins at Step S210, wherein a user attempts to open and read a DRM-protected document. Again, this step may be performed on a user computer or terminal 20, or at a terminal connected to a content provider server such as the LMS server 30 or the RMS server 40. The DRM-protected document may be stored in a memory or storage device of the user computer or terminal 20, the LMS server 30 or the RMS server 40.

At Step S212 the program, such as Adobe's Acrobat Reader, used by the user to try to open the document needs to check whether the user has the appropriate rights to access the document. The program may access a content provider's server such as the RMS server 40 via the network 60 and provide the document ID and the user ID, and the step of checking whether the user has the necessary rights may be performed at the RMS server 40. The document ID may be a globally unique ID (GUID). The RMS server may check with database stored in an internal or external memory or storage device (e.g. the storage 50) to determine whether the user ID is associated with the document ID as an authorized user. At Step S214 if the RMS server determines that the user is not an authorized user of the document, then it will deny the user's rights to access and use the document.

At Step S216 a digital message file is pre-generated by the RMS server. Alternatively the digital message file is pre-generated by the reader application on the user computer. At Step S220 the pre-generated message file is presented to the user on the user's computer or terminal through, for example, a web-browser showing a window or page of a website provided by the RMS server. The pre-generated message file may be, for example, a HyperText Markup Language (HTML) page file, which may be packaged together with the PDF document file, for example, in a same zip folder.

Since a message associated with the PDF document needs to support HTML in order to display it on the user computer, e.g. through a web browser, either a plugin for an existing PDF reader (such as the Adobe® Acrobat Reader, which only supports plain-text for standard messages associated with authentication) or a tailored DRM-protected document reader needs to be provided. The plugin/reader application is used to communicate with the RMS server to determine what message is to be sent to the user based on the specific document, the DRM policy, and the user. Pre-generated HTML form can be bundled with the PDF document within a self-extracting archive with instructions to the user to use the HTML file, in a folder, or just the HTML itself.

The HTML file may be pre-generated as a form page which can be pre-populated and loaded with information about the PDF document file, such as the GUID of the document. This HTML page may automatically redirect this information using JavaScript® upon loading of the page. The reader program may also display a message to prompt the user to open the HTML page file.

At Step S222, the user fills out the remaining fields on the HTML form with required information, e.g., credit card information, for purchasing or otherwise acquiring necessary rights to the document. The HTML file with the form page(s) may be hosted by the RMS server.

At Step S224, once the HTML form hosted by the RMS server is completed, the RMS server will proceed to finalize and complete the user's purchase of the rights to the document. At Step S226 the database can be updated with the user's ID can be added to the policy ID associated with the document ID stored in the database. At Step S228 the rights to access and use the document are granted to the user. At Step S230, the user can open and read the document now as these rights are granted to the user.

Again, the dotted boxes in FIG. 4 indicate typically what steps are performed by or at which system. For example, the dotted box on the left indicates that Steps S210, S220 and S230 are typically performed at the user's computer (or a terminal connected to the LMS or RMS server), and the dotted box on the right indicates that Steps S212-216 and S222-228 are typically performed by a content provider's server such as the RMS server. Again, alternative arrangement may be utilized to perform these steps.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing user access of a document protected by digital rights management (DRM), comprising the steps of:
a server checking whether a user who is attempting to access a DRM-protected document has necessary rights to access the document;
the server denying the user's access to the document if the user does not have the necessary rights to access the document;
the server providing, if the user does not have the necessary rights to access the document, the user with an instant and pre-prepared prompt containing a unique identification (ID) of the document to direct and assist the user to complete required tasks for acquiring rights to the document; and
upon completion of the required tasks by the user, the server granting the necessary rights to the user to access the document.

2. The method of claim 1, wherein the instant and pre-prepared prompt is a text message.

3. The method of claim 2, wherein the text message contains a Uniform Resource Locator (URL) linking to a DRM website.

4. The method of claim 3, wherein the URL also contains an ID of the user.

5. The method of claim 3, wherein the URL also contains an ID of a DRM policy associated with the document.

6. The method of claim 1, wherein the instant and pre-prepared prompt is a HyperText Markup Language (HTML) page.

7. The method of claim 6, wherein the HTML page is pre-populated with information associated with the document.

8. The method of claim 6, wherein the HTML page automatically redirects to a DRM website.

9. The method of claim 6, wherein the HTML page is contained in a digital file.

10. The method of claim 9, wherein a digital file of the document is packaged together with the digital file of the HTML page.

11. A computer program product comprising a non-transitory computer usable medium having a computer readable code embodied therein for controlling a data processing apparatus, the computer readable program code configured to cause the data processing apparatus to execute a process for managing user access of a document protected by digital rights management (DRM), the process comprising the steps of:
a server checking whether a user who is attempting to access a DRM-protected document has necessary rights to access the document;
the server denying the user's access to the document if the user does not have the necessary rights to access the document;
the server providing, if the user does not have the necessary rights to access the document, the user with an instant and pre-prepared prompt containing a unique identification (ID) of the document to direct and assist the user to complete required tasks for acquiring rights to the document; and
upon completion of the required tasks by the user, the server granting the necessary rights to the user to access the document.

12. The computer program product of claim 11, wherein the instant and pre-prepared prompt is a text message.

13. The computer program product of claim 12, wherein the text message contains a URL linking to a DRM website.

14. The computer program product of claim 13, wherein the URL also contains an ID of the user.

15. The computer program product of claim 13, wherein the URL also contains an ID of a DRM policy associated with the document.

16. The computer program product of claim 11, wherein the instant and pre-prepared prompt is a HTML page.

17. The computer program product of claim 16, wherein the HTML page is pre-populated with information associated with the document.

18. The computer program product of claim 16, wherein the HTML page automatically redirects to a DRM website.

19. The computer program product of claim 16, wherein the HTML page is contained in a digital file.

20. The computer program product of claim 19, wherein a digital file of the document is packaged together with the digital file of the HTML page.
